(19) United States
(12) Patent Application Publication
(10) Pub. No.: US 2017/0356629 A1
(43) Pub. Date: Dec. 14, 2017

(54) BASE CAN FASTENING SYSTEM

(71) Applicant: MCB Industries, Inc., De Pere, WI (US)

(72) Inventors: Mary Chris Baeten, De Pere, WI (US); Anthony Brien Eisemann, McHenry, IL (US)

(73) Assignee: MCB Industries, Inc., De Pere, WI (US)

(21) Appl. No.: 15/613,586

(22) Filed: Jun. 5, 2017

Related U.S. Application Data
(60) Provisional application No. 62/349,928, filed on Jun. 14, 2016.

(51) Int. Cl. F21V 17/12; F21V 21/14; F21W 111/06; H01R 33/09; B64F 1/20; H01J 9/30

(52) U.S. Cl. CPC F21V 17/12; F21V 21/14; H01J 9/30; H01R 33/09; B64F 1/205; F21W 2111/06

(57) ABSTRACT

A fastening system for coupling an object having object openings to a base can with a flange having base can apertures. The fastening system includes a clip with an upper arm and a lower arm each extending from a spreader that separates the upper and lower arms. The clip is configured to engage the flange such that the flange is positioned between the upper and lower arms. The clip is configured to retain a nut having a nut opening with internal threads between the lower arm and the flange such that the nut opening is aligned to one of the base can apertures. A coupling system with a threaded member is configured to couple the object to the base can by extending at least through one object opening and one base can aperture, and also extending at least partially into the nut opening to engage the nut.

### CROSS REFERENCE TO RELATED APPLICATION

This application claims the benefit of U.S. Provisional Patent Application No. 62/349,928, filed Jun. 14, 2016, which is incorporated herein by reference in its entirety.

### BACKGROUND

The present disclosure generally relates to a base can fastening system. More specifically, the present disclosure relates to a fastening system that retains a nut under a base can flange to engage a bolt inserted from above.

Base cans are generally known in the art and serve as anchoring devices for removably attaching an object. In particular, the base can may be permanently fixed in an underlying material that may not be conducive to attaching the object directly thereto. Similarly, a base can may provide an enclosure for retaining and protecting portions of the object and related equipment. In some cases, the object itself serves as a cover for the enclosure upon attachment to the base can. One common application for base cans is with electrical installations, using the base can as a convenient and standardized receptacle for anchoring an electrical fixture while also protecting its wiring from the elements by containing them therein.

Base cans are often cylindrical in shape, having curved sidewalls and often an at least partial bottom wall. The top end, opposite of the bottom wall if present, is generally at least partially open and includes a flange extending radially inwardly from the circumference of the base can sidewalls. This flange often contains a plurality of threaded base can apertures that are spaced evenly around the circumference of the open top end of the base can. This configuration provides an interface for attaching objects to the base can by inserting couplers, such as bolts from above. In this arrangement, the object attached to the base can effectively closes the base can, which may then be further sealed from the elements by placing intermediate seals or gaskets between the object and the base can before attachment.

One particularly challenging application for base cans is within the context of airport lighting, which relies upon base cans being fixed within the runway to anchor in-runway lighting. Mounting base cans and light fixtures within a runway presents many unique challenges, including the need to withstand tremendous forces of airplanes landing and taking off, the need to support quick repairs and replacements to the light fixtures to avoid runway down-time, and the need to maintain a flush runway surface to ensure the safety of the airplane and its passengers.

The base cans, lighting fixtures, and fastening systems presently known in the art attempt to meet these challenges as follows. The durability of these elements, as well as the specifications of fasteners for attaching light fixtures to base cans, are specified by the Federal Aviation Administration (FAA) to ensure that they can withstand the demands of in-runway installations. The time for repairs and replacements of light fixtures is reduced by using commonly known, threaded bolts (albeit, meeting FAA specifications) to install the fixtures from above, standardizing the process and tools involved. Annular spacers are often used as needed to offset the distance between the base can flange and the object, allowing the installed height to be adjusted until it is flush with the surrounding runway surface.

A seating ring may also be installed between any spacers and the light fixture, which may contain a recessed surface below the upper surface to allow the fixture to be at least partially nested down within the seating ring upon installation. This arrangement may provide additional benefits, such as providing a seal or supporting the fixture by a lip between the upper surface and the recessed surface of the seating ring.

### SUMMARY

One embodiment of the present disclosure generally relates to a fastening system for coupling an object to a base can. The base can has a flange with an upper surface and a lower surface and defines a plurality of base can apertures through the flange. The object defines a plurality of object openings through the object. The fastening system includes a clip having an upper arm and a lower arm that each extend from a spreader, where the spreader separates the upper arm and lower arm. The clip is configured to engage the flange such that the flange is positioned between the upper arm and the lower arm. A nut has a nut base and a plurality of sides that extend perpendicularly from the nut base. The nut defines a nut opening with internal threads. The clip is configured to retain the nut between the lower arm and the lower surface of the flange such that the nut opening is aligned to a base can aperture of the plurality of base can apertures. A coupling system having a threaded member is configured to couple the object to the base can. When the object is coupled to the base can, the threaded member extends at least through one of each of the plurality of object openings in the object and the plurality of base can apertures in the flange, and the threaded member also extends at least partially into the nut opening to engage the nut.

Another embodiment generally relates to a fastening system for coupling an object to a base can with a coupling system and a nut. The nut has a lip and defines a nut opening. The base can has a sidewall with an upper end, a lower end that is opposite the upper end, and a flange that extends radially inwardly and perpendicularly from the upper end of the sidewall. The flange has an upper surface and a lower surface and defines a plurality of base can apertures through the flange. The object defines a plurality of object openings through the object. The fastening system includes a clip configured to engage the flange of the base can. The clip has a spreader and an upper arm, a middle arm, and a lower arm that are each coupled to and separated by the spreader. The upper arm defines an upper opening, the middle arm defines a middle opening, and the lower arm defines a lower opening. In certain embodiments, the upper opening, the middle opening, and the lower opening are axially aligned. The clip is configured to engage the flange such that the flange is positioned between the upper arm and the middle arm. A spacer is positionable between the upper surface of the flange and the object. The spacer has an upper surface and a lower surface and defines a plurality of spacer openings though the spacer. The lower surface of the spacer further defines a plurality of clip grooves that extend towards the upper surface of the spacer, where the plurality of spacer openings coincide with the plurality of clip grooves. The plurality of clip grooves are configured to accommodate the upper arm of the clip such that the upper arm does not prevent the lower surface of the spacer from contacting the upper surface of the flange when the clip is engaged with the flange and the spacer is positioned between the flange and the object. The clip is configured to retain the lip of the nut between the middle arm and the lower arm such that the nut opening is aligned to one base can aperture of the plurality of base can apertures. When the object is coupled to the base can, the threaded member extends at least through one of each of the plurality of object openings in the object, the plurality of spacer openings, the upper opening of the clip, the plurality of base can apertures in the flange, and the middle opening of the clip, and the threaded member also extends at least partially into the nut opening to engage the nut.

Another embodiment generally relates to a fastening system for coupling an object to a base can. The base can has a sidewall with an upper end and a lower end that is opposite the upper end, where the base can has a flange that extends radially inwardly and perpendicularly from the upper end of the sidewall. The flange has an upper surface and a lower surface and defines a plurality of base can apertures through the flange. The object defines a plurality of object openings through the object. The fastening system includes a clip configured to engage the flange of the base can, where the clip has a spreader and an upper arm, a middle arm, and a lower arm that are each coupled to and separated by the spreader. The upper arm defines an upper opening, the middle arm defines a middle opening, and the lower arm defines a lower opening. In certain embodiments, the upper opening, the middle opening, and the lower opening are axially aligned. The clip is configured to engage the flange such that the flange is positioned between the upper arm and the middle arm. A coupling system has a threaded member. A nut has a lip and a plurality of sides that extend perpendicularly from the lip, where the nut defines a nut opening having internal threads. The internal threads are threadably engageable with the threaded member of the coupling system. The clip is configured to retain the lip between the middle arm and the lower arm. A spacer is positionable between the upper surface of the flange and the object, where the spacer has an upper surface and a lower surface and defines a plurality of spacer openings through the spacer. The lower surface of the spacer further defines a plurality of clip grooves that extend towards the upper surface of the spacer, where the plurality of spacer openings coincide with the plurality of clip grooves. The plurality of clip grooves are configured to accommodate the upper arm of the clip such that the upper arm does not prevent the lower surface of the spacer from contacting the upper surface of the flange when the clip is engaged with the flange and the spacer is positioned between the flange and the object. The clip is configured to retain the lip of the nut between the middle arm and the lower arm such that the nut opening is aligned to one base can aperture of the plurality of base can apertures. When the object is coupled to the base can, the threaded member extends at least through one of each of the plurality of object openings in the object, the plurality of spacer openings, the upper opening of the clip, the plurality of base can apertures in the flange, and the middle opening of the clip, and the threaded member also extends at least partially into the nut opening to engage the nut.

### BRIEF DESCRIPTION OF THE DRAWINGS

The drawings illustrate the best mode presently contemplated of carrying out the disclosure. In the drawings:

FIG. 1 is an isometric view of a base can and fixture assembly as presently known in the art;

FIG. 2A is a partial top view of a base can in accordance with the present disclosure;

FIG. 2B is a sectional view of the base can of FIG. 2A taken from line 2B-2B of FIG. 2A shown with an optional chamfer;

FIG. 2C is a bottom view of the base can of FIG. 2B;

FIG. 3A is a top view of one embodiment of a clip from the fastening system of the present disclosure;

FIG. 3B is a side view of the clip shown in FIG. 3A with a nut configured to be retained therein;

FIG. 3C is a side view of the clip shown in FIG. 3A with the nut retained therein;

FIG. 3D is a bottom view of the arrangement shown in FIG. 3B;

FIG. 3E is a bottom view of the arrangement shown in FIG. 3C;

FIG. 4A is a front view of the clip shown in FIG. 3A;

FIG. 4B is a sectional view taken from the line 4B-4B in FIG. 4A;

FIG. 5 is an isometric view of the clip and nut assembly shown in FIGS. 3C and 3E, further including a bolt threaded through the assembly and onto the nut;

FIG. 6A is a top view of a spacer of the presently disclosed fastening system configured to be supported on the base can shown in FIG. 2A;

FIG. 6B is a sectional view taken from line 6B-6B in FIG. 6A;

FIG. 6C is a sectional view taken from line 6C-6C in FIG. 6A;

FIG. 6D is a bottom view of the spacer shown in FIG. 6A;

FIG. 7A is a top view of the presently disclosed fastening system installed on the base can shown in FIG. 2A;

FIG. 7B is a sectional view taken from line 7B-7B of FIG. 7A;

FIG. 7C is a bottom view of the assembly shown in FIG. 7A;

FIG. 8A is a bottom-back perspective view of one embodiment of the presently disclosed fastening system installed on a base can similar to the assembly shown in FIG. 7C, but with the base can sidewalls removed;

FIG. 8B is a front-side perspective view of the fastening system shown in FIG. 8A;

FIG. 8C is a top perspective view of the fastening system shown in FIG. 8A, similar to the assembly shown in FIG. 7A, but without a spacer installed;

FIG. 9A depicts one coupling system and a pair of wedge lock washers known in the art;

FIG. 9B depicts a sectional view of a nut in accordance with the present disclosure having internal threads with different pitches;

FIG. 9C depicts an embodiment of the coupling system in accordance with the present disclosure; and

FIG. 9D is a side view of the coupling system of FIG. 9C coupling an object to a base can in accordance with the present disclosure.

### DETAILED DISCLOSURE

Embodiments of the base can fastening system are described herein.

Through observation and product development, the present inventors have identified problems with base cans and fastening systems known in the art. One application in which this was identified is within the field of runway light fastening systems. Although this disclosure often discusses the presently claimed subject matter in the context of runway lighting, it should be recognized that the following relates to attaching any object to any structure analogous to a base can.

One exemplary problem identified by the present inventors is that the threaded openings or apertures in the flange of presently known base cans often become stripped over time. These are also prone to bind with a bolt inserted therein, resulting in the bolt breaking off and the broken portion of the bolt remaining within the threaded opening of the base can flange. In the context of runway lighting fixtures, this problem is further exacerbated by the fact that the presently known and used base cans are not regulated to the same specifications as the fasteners used to attach fixtures to them, resulting in base cans being made of a lower grade material that is more likely to become damaged.

Since the integrity of fastener systems for attaching objects such as lights to a runway is critical to the safety of both airplanes and their passengers, damaged base cans must be repaired such that each light fixture remains fixed to the base can with the necessary quantity of fasteners and corresponding threaded base can apertures in fully functional form. In the case of a stripped aperture thread, there is little that can be done to restore the thread integrity while allowing the same standardized bolt to be used in that aperture. In the case of a broken bolt, the fragment must be removed or otherwise drilled out in order to restore an open aperture through the flange. However, this too may result in widening of the aperture diameter or damage to the threads, leading to the inability to engage the aperture using the same standardized bolt used in the other apertures.

Furthermore, any such repairs to stripped threads, or efforts to remove a broken bolt fragment, are further complicated in the context of a base can assembly that is permanently fixed within a concrete runway surface, making repairs both difficult and expensive. The present inventors have identified a need to improve the speed and efficacy of making such repairs within the narrow time window that a technician has available between runway uses, as well as a solution to prevent damage and/or to accommodate repair more readily for future base cans being installed.

One of the most significant expenses for repairing damaged base cans arises from stripped threads, which require the base can to be removed from the concrete runway surface in order to install a new base can having fully functioning threads. Since a runway must have an exceptionally flat and even surface, removal and replacement of a base can generally requires a section of the runway concrete surrounding the base can to be removed and re-poured in conjunction with the newly installed base can.

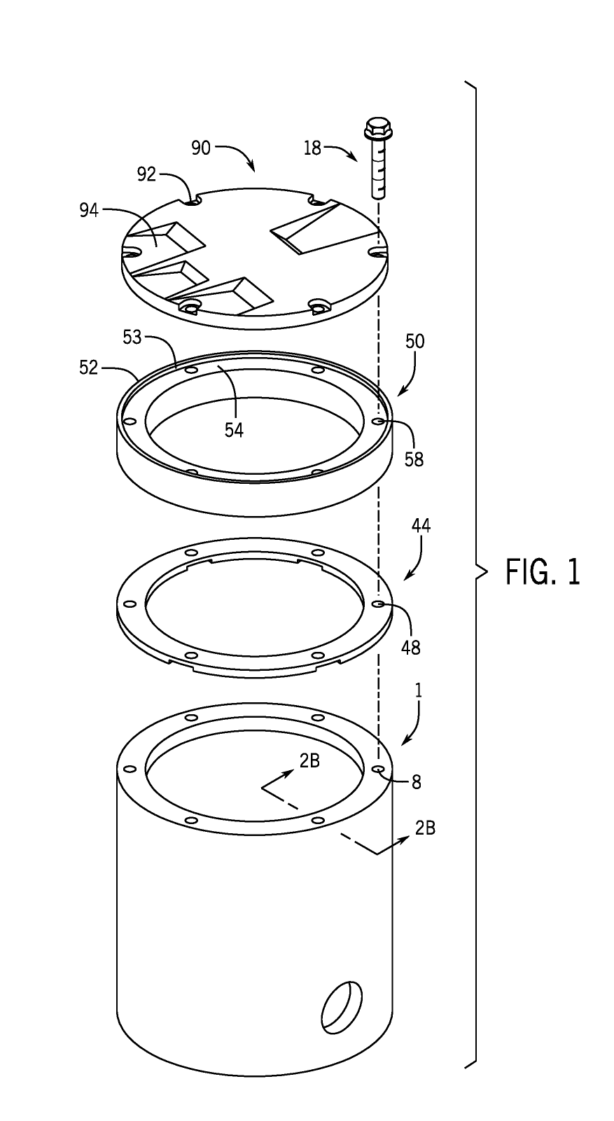

FIG. 1 depicts one such base can and fastening system as known in the art. As shown, the assembly includes a base can 1 having a plurality of threaded base can apertures 8, a spacer 44 having a plurality of spacer openings 48 that align with the base can apertures 8, a seating ring 50 having a plurality of seating ring openings 58 that align with the spacer openings 48, and an object 90 having object openings 92 that align with the seating ring openings 58. After properly aligning these elements, the object 90 is coupled or secured to the base can 1 using a coupling system 18, shown here as a bolt inserted from above, which will be discussed in detail below. In the example shown, the object 90 is a runway light fixture having light emitters 94.

In practice, the base can 1 is permanently fixed within the concrete of a runway. Once the concrete has hardened, an appropriate number of spacers 44 are placed on the base can 1 to ensure the desired overall installation height, a seating ring 50 is placed on the spacers 44, and an object 90 is secured to the base can from above by inserting a series of coupling systems 18. Any subsequent repairs are performed on the runway, as the base can 1 is fixed within the concrete.

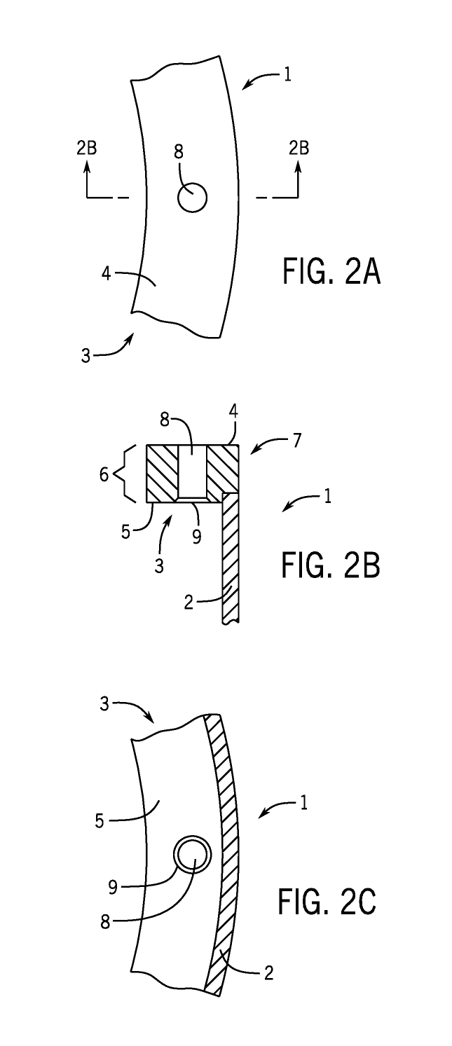

FIGS. 2A-2C illustrate a cutaway portion of an exemplary base can 1 to which an object 90 may be coupled or secured by the presently disclosed fastening system. As described above, presently known base cans 1 often have sidewalls 2 that are cylindrical and at least a partial bottom wall (not shown). The top end 7 of the sidewalls 2 opposite of the at least partial bottom wall is generally at least partially open and often includes a flange 3. As shown in FIG. 2B or FIG. 2A, the flange 3 extends radially inwardly from the circumference of the top end 7 of the sidewalls 2. A plurality of threaded base can apertures 8 are defined within the flange 3 and are spaced evenly around the circumference of the open top end 7 of the base can 1. The upper surface 4 of the flange 3 and the base can apertures 8 provide an interface for an object 90 to be fastened to the base can 1 by inserting a coupling system 18, such as a bolt, downwardly through the object 90 and into one of the threaded base can apertures 8 of the base can flange 3.

While FIGS. 2A-2C generally depict a base can 1 as known in the art, the figures include the addition of a chamfer 9 that cooperates with the presently claimed fastening system, thus depicting an improved base can 1. This will be discussed in detail below.

Beyond the improvement for new base cans 1, the present inventors have designed and developed the presently disclosed fastener system to allow an existing base can 1 to be restored to functioning condition after the threaded base can apertures 8 have been damaged or rendered otherwise unusable. Specifically, the present inventors have developed a fastening system 100 that enables a new nut 12 having fully functional threads within the nut opening 16 defined therein to be retained under a damaged base can aperture 8 of the base can flange 3, allowing the threaded nut opening 16 to be engaged by a coupling system 18 to couple an object 90 to the base can flange 3 regardless of the condition of the threads within the base can aperture 8.

It should be noted that although this disclosure generally refers to base cans 1 oriented with the open end facing upwardly, and in the context of in-runway lighting, the present disclosure anticipates use of the disclosed fastening system for any base cans, such as overhead lighting or other applications.

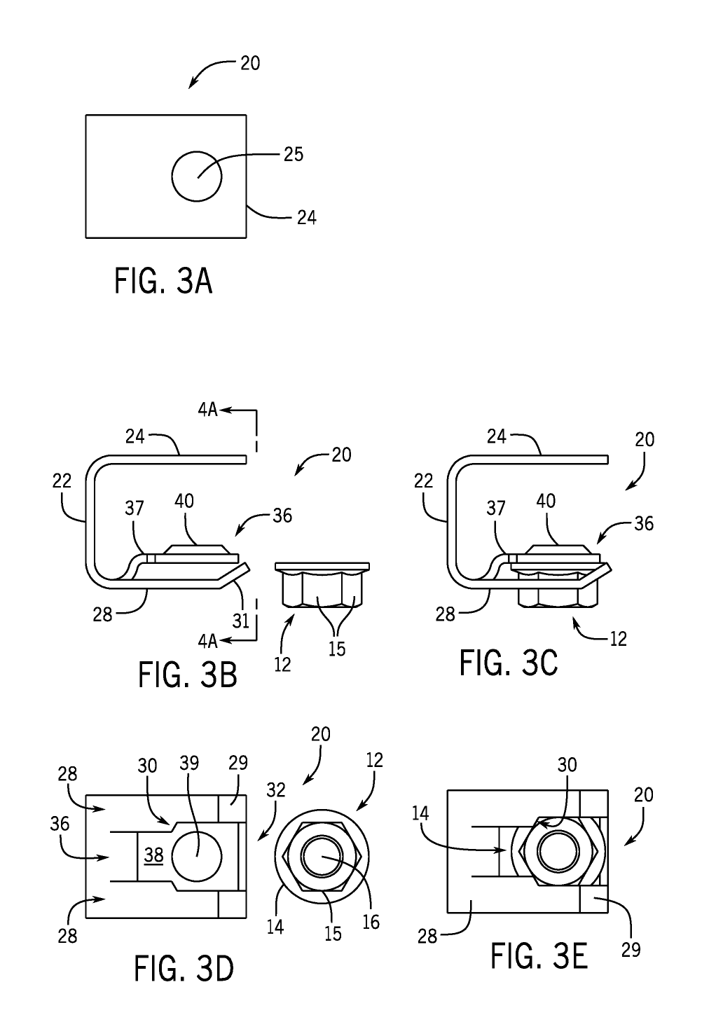

FIGS. 3A-3E show one embodiment of the present fastening system having a substantially C-shaped clip 20 that attaches onto the base can flange 3 shown in FIG. 2B. The clip 20 supports and retains a new, fully functional nut 12 under the flange 3 to be threadably engaged by a coupling system 18, such as a hex head bolt, to fix an object 90 (each shown in FIG. 1) to the flange 3 from above. The clip 20 is comprised of an upper arm 24 spaced apart from the lower arm 28 by a spreader 22, whereby the upper arm 24 and lower arm 28 are substantially parallel and the spreader 22 is substantially perpendicular to the upper arm 24 and the lower arm 28. The height of the spreader 22 is configured to be substantially equal to the thickness between the upper surface 4 and lower surface 5 of the base can flange 3. Since the bolt must now extend fully-through a drilled-out or striped flange opening 8, a longer bolt may be required as compared to the original installation using functional apertures 8. Other than meeting FAA specifications, the coupling system 18 includes a variety of devices generally known in the art. These include a bolt having a head on a first end opposite of a tip on a second end and being threaded along the length of the shaft (see FIG. 1 generally). However, it also includes a combination of threaded rod with bolts, as would be understood by one having ordinary skill in the art.

The present inventors have identified another embodiment of the present disclosure as being particularly advantageous in the context of runway repair. Frequently, runway resurfacing requires an extension 60 to be placed above flange 3 of base cans 1 set within the runway. These extensions 60 have been observed to shift relative to the base can 1 over time and through use, causing shearing or other damage any coupling systems 18 used to couple an object 90 to the base can 1. There are presently no known methods or devices for solving this problem.

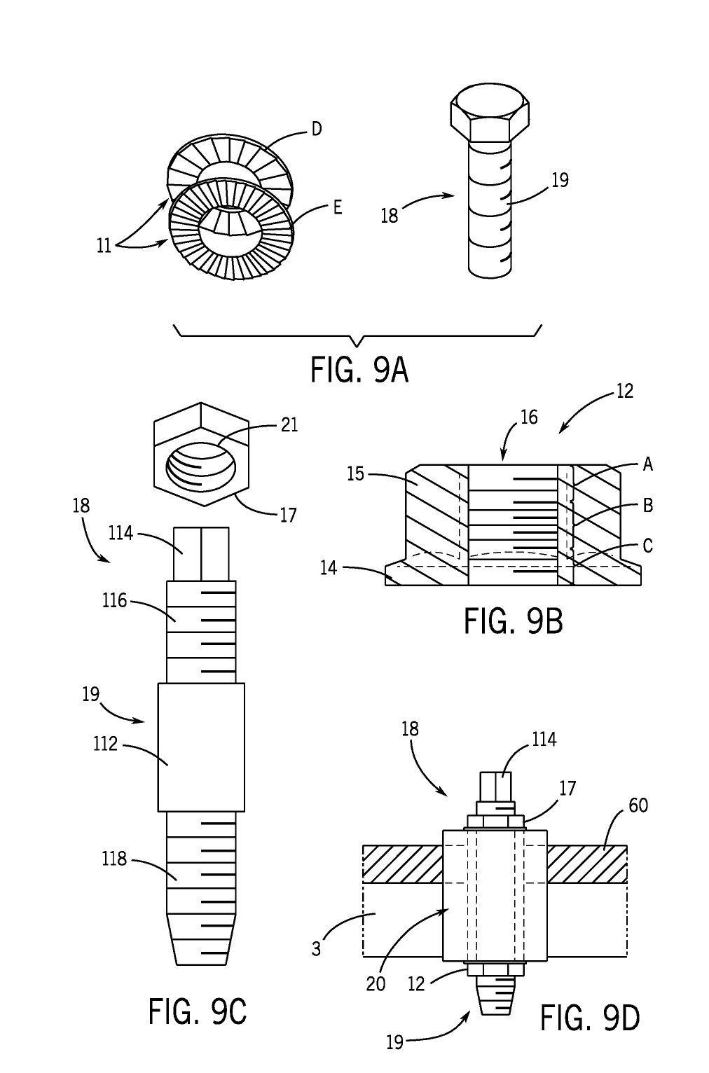

FIGS. 9C-9D depict an embodiment configured to resolve the challenges relating to the use of extensions 60 described above. As shown, the coupling system 19 has top threads 116 and bottom threads 118 on threaded member 19, with a stop 112 positioned therebetween to limit the respective threadable engagements of a top nut 17 and a nut 12. A hex cap 114 near the top allows the coupling system 18 to be rotated with an external tool to threadably engage the nut 12. This fixes the extension 60 to the base can 1 (via flange 3) when an extension 60 is required to modify the height of the base can 1 following a resurfacing of the runway. In this configuration, a taller clip 20 is required such that the clip 20 can engage both the flange 3 and the extension 60 to couple them together via the coupling system 19 as shown. In the context of FIG. 1, which shows a base can known in the art, the extension 60 requiring accommodation by the embodiment of clip 20 discussed above would be positioned between the flange 3 and any spacer 44 and/or seating ring 50 used, as well as the object 90.

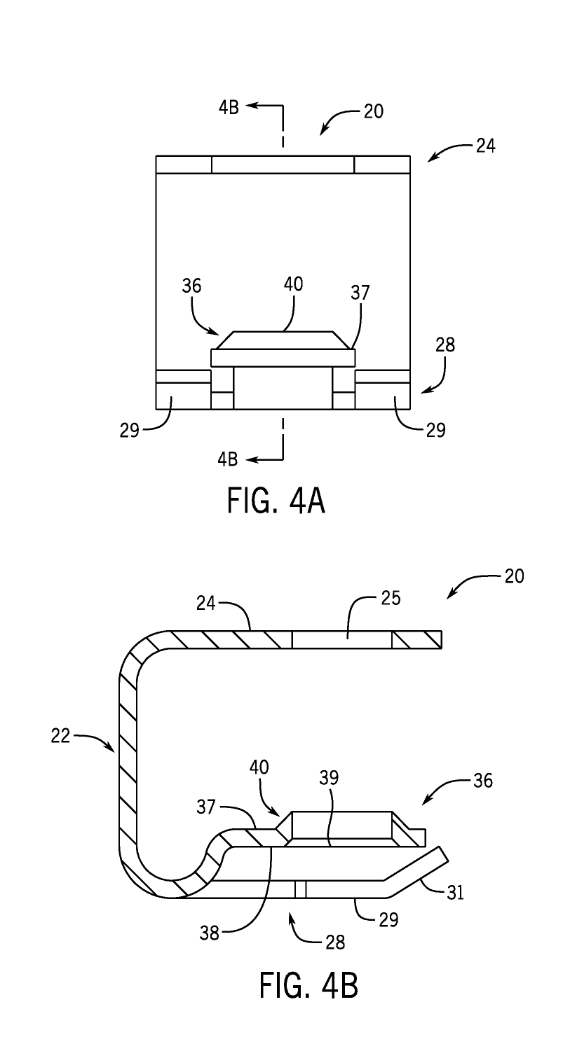

Returning to the embodiment shown in FIG. 3B, the clip 20 further includes a middle arm 36 disposed between the upper arm 24 and lower arm 28. Certain embodiments do not include a middle arm, including some that incorporate a threaded opening within the lower arm 28, as is discussed below. Also shown in the embodiment of FIG. 3B is a nut 12 having a lip coincident with its nut base 14, whereby the nut 12 can be slideably inserted between the middle arm 36 and lower arm 28. Specifically, the middle arm 36 and lower arm 28 sandwich the nut base 14 to engage the nut 12, as shown in FIG. 3C. In some embodiments, the tip 31 of one or more finger 29 may be bent in an upward direction towards the upper arm 24 or middle arm 36 to improve retention of the nut 12 within the clip 20, as shown in FIG. 4B.

FIG. 3D further depicts an embodiment of clip 20 wherein the lower arm 28 is comprised of two fingers 29, whereby the fingers 29 retain the nut base 14 of the nut 12 between the middle arm 36 and the lower arm 28. Each finger 29 may also define an opening to together define a notch 30 therebetween. The notch 30 is configured to contact one or more sides 15 of the nut 12 to prevent its rotation. It is anticipated by the present disclosure that the nut 12 need not be hexagonal, but need only have one or more side 15 or other feature to engage with a finger 29 or the notch 30 of a finger 29 in the presently disclosed embodiment. Alternatively, the present disclosure also anticipates that the nut 12 may be integral with the clip 20, eliminating the need for engagement between a side 15 of the nut 12 and the finger 29 or notch 30 to prevent rotation of the nut 12 relative to the clip 20. As discussed above, integrating the nut 12 and the clip 20 eliminates the need for both the middle arm 36 and lower arm 28, as the nut 12 may be attached to either one, eliminating the need for the other. Similarly, the present disclosure anticipates configurations in which the nut 12 is not integral to the lower arm 28, and wherein the nut 12 engages directly with the lower surface 5 of the flange 3, rather than with a middle arm 36.

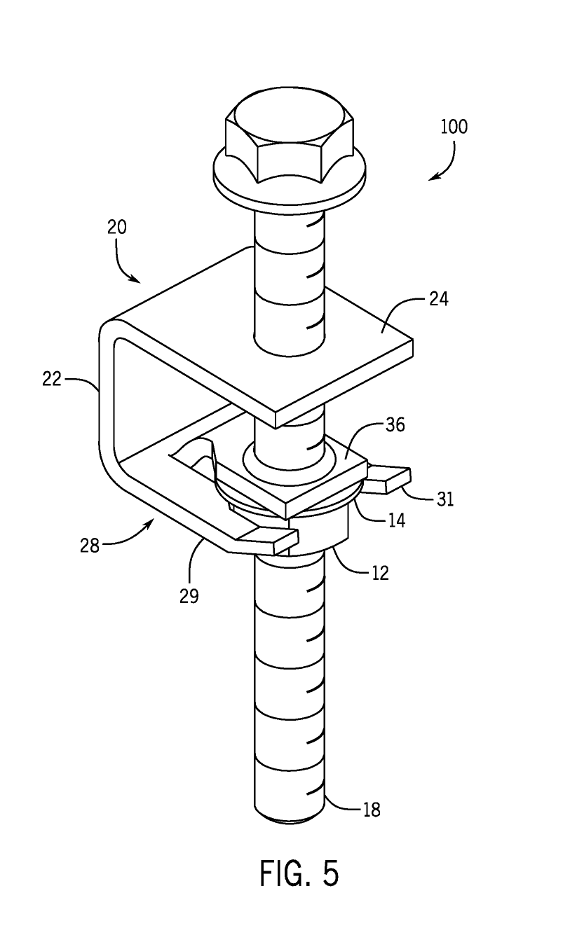

FIGS. 3A-3E further illustrate the alignment of openings within the clip 20—the upper opening 25 in the upper arm 24, the middle opening 39 of the middle arm 36, the lower opening 32 of the lower arm 28—such that a coupling system 18 (shown in FIG. 1) is insertable through the clip 20 to be threaded into nut opening 16 of the nut 12 to fix an object 90 to the base can 1 from above. As such, the clip 20 in practice is aligned to a base can aperture 8 in the base can flange 3 that has defective threads, has been drilled out, or is otherwise in need of replacement. The assembly of the coupling system 18, clip 20, and nut 12 is also shown in FIG. 5, though it should be noted that the object 90, optional seating ring 50, optional spacer 44, and base can flange 3 are omitted in this illustration.

It should be recognized that while the openings in the clip 20 are in some embodiments depicted as circular holes, these openings may have other shapes and also need not be enclosed, such as shown for lower opening 32.

The inventors have further developed an improvement to new base cans 1 to accommodate the presently disclosed fastening system 100 for use in repairing newly manufactured base cans 1 as they become damaged in the future. For example, the embodiment of FIG. 3B has a middle arm 36 of the clip 20 with a raised alignment feature 40, shown as frustoconical shape surrounding the middle opening 39. This alignment feature is shown to extend upwardly from the upper surface 37 of the middle arm 36 and to match a corresponding frustoconical chamfer 9 within the lower surface 5 of the base can flange 3 that surrounds the flange opening 8. The mating of the alignment feature 40 on the clip 20, with the chamfer 9, assists in aligning or maintaining alignment of the clip 20 and nut 12 relative to the base can base can aperture 8 before the threaded member 19 has been inserted through the base can aperture 8 to fix this alignment.

In other embodiments, the fit and friction between the upper surface 37 of the middle arm 36 and the lower surface 5 of the flange 3 is sufficient to maintain alignment of the clip 20 to the flange 3 without an alignment feature 40 and chamfer 9. Therefore, the presently disclosed fastening system 100 also functions with existing base can installations.

In base can 1 assemblies known in the art, a pair of wedge lock washers 11 are routinely installed between the object 90 and the coupling system 18 in circumstances where vibrations may cause loosening over time (shown in FIG. 9A). Specifically, each of the wedge lock washers 11 have a coarse pitch D on one side and a fine pitch E on the other side. The two coarse pitches D are positioned in contact with one another in use, as would be known to one having ordinary skill in the art.

While the presently disclosed fastening system 100 can incorporate wedge lock washers 11 as known in the art, the present inventors have further identified improvements by instead using a nut 12 having variable pitches within the nut opening 16. In the embodiment of FIG. 9B, the nut 12 has a first pitch A, second pitch B, and third pitch C. The present inventors have identified that this variable pitch serves as a mechanical lock on the coupling system 18 to prevent loosening over time. Exemplary products providing this functionality are offered for sale by Spiralock® and reduce the overall parts required in the presently disclosed fastening system 100.

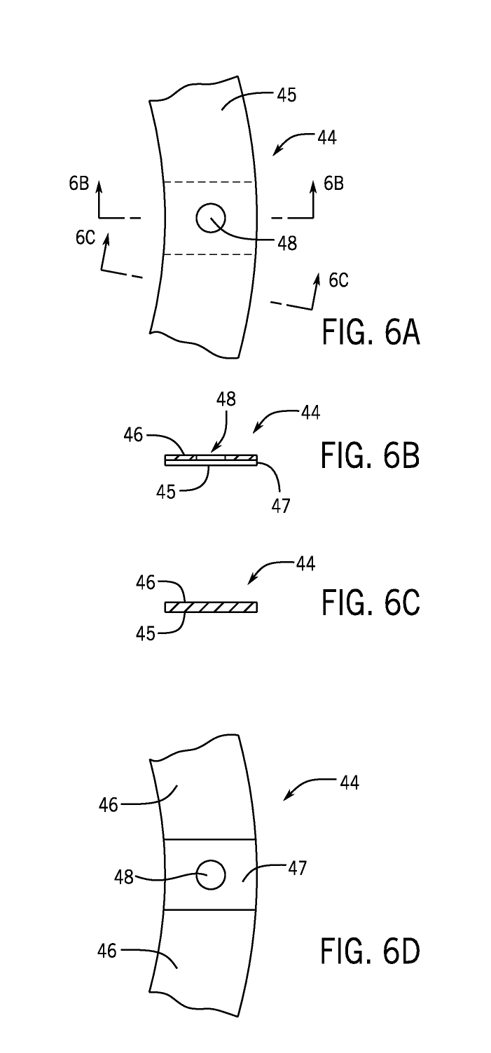

As discussed above, the presently known base can systems commonly include the use of spacers, as necessary, to ensure that the final installation of an object 90 on the base can 1 remains at a height that is substantially flush with the runway surface. However, the present inventors have also identified that the use of a clip that attaches onto the base can flange would interfere with the presently known spacers making contact with the base can flange upper surface. Accordingly, the present inventors have developed an improved spacer 44 to accommodate the use of the clip 20 in the presently disclosed fastening system, as shown in FIG. 6A.

FIGS. 6A-D depict one embodiment of a spacer 44 configured to be placed on flange 3 to provide the necessary offset for a shorter object fixed to the base can. In some cases, multiple spacers may be necessary to achieve the desired overall assembly height.

The spacer 44 contains one or more clip groove 47 in the lower surface 46 of the spacer 44 that each substantially correspond a spacer opening 48 through the spacer 44. The clip groove 47 is configured to be at least the size of the upper arm 24 of the clip 20 such that the clip groove 47 may fully accommodate the upper arm 24 therein when the spacer 44 is placed on the upper surface 4 of the base can 1 flange 3 with a clip 20 attached thereto. The clip groove 47 may be substantially larger than the dimensions of the upper arm 24 of the clip 20, and in fact, the portion of the spacer 44 comprised of clip grooves 47 may be substantially greater than the portion of the lower surface 46 that makes contact with the upper surface 4 of the base can flange 3.

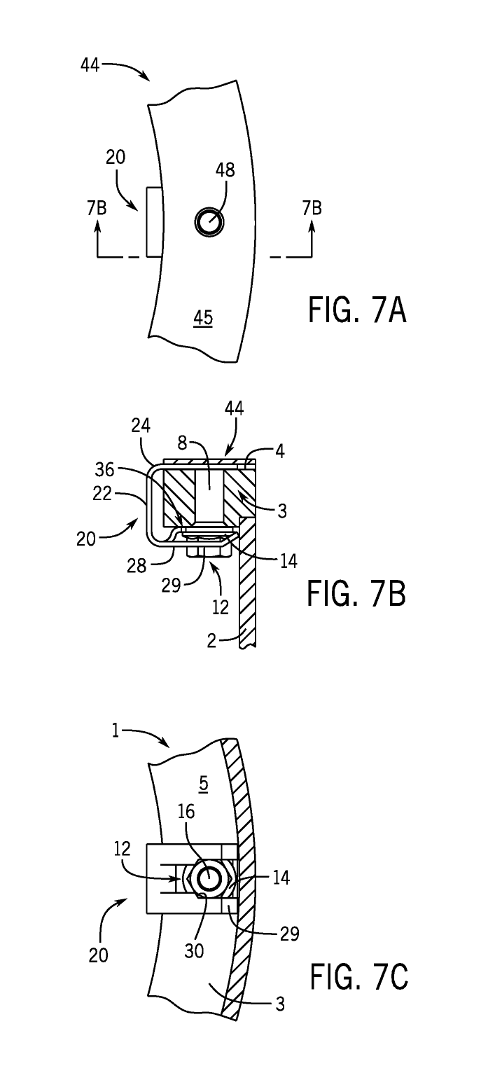

FIGS. 7A-C show a partial view of a base can 1 with a clip 20 retaining a nut 12 attached to the base can flange 3, along with a spacer 44 placed above the clip 20, in accordance with the present disclosure. Specifically, FIG. 7A is a partial top view of a spacer 44 disposed on the upper surface 4 of a base can 1 with a clip 20 installed. FIGS. 7B and 7C demonstrates the alignment of the spacer openings 48 in the spacer 44 with the upper opening 25, the middle opening 39, and the lower opening 32 of the clip 20, with the base can apertures 8 of the base can flange 3, and with the nut opening 16 of the nut 12 upon installation of the clip 20 and the spacer 44 onto the flange 3.

An optional seating ring 50 may be placed on the upper surface 45 of the spacer 44 shown in FIGS. 7A-7C to provide an interface for mounting the object 90 as shown in FIG. 1. Also as shown in FIG. 1, the seating ring 50 includes three substantially parallel surfaces: an upper surface 52, a lower surface 56, and a recessed surface 54 therebetween. The circumferential wall created between the upper surface 52 and the recessed surface 54 forms a lip 53 that may provide support and alignment for the object 90 to be placed on the recessed surface 54. A plurality of seating ring openings 58 extend through the seating ring 50 between the recessed surface 54 and lower surface 56 and are spaced evenly around the circumference of the seating ring 50 to substantially vertically align with the spacer openings 48 of the spacer 44 below.

In this arrangement, the object 90 is coupled or secured to the base can 1 by inserting a coupling system 18, such as a bolt, into an opening 92 in the object 90, through a seating ring opening 58 in the seating ring 50, through a spacer opening 48 in the spacer 44, through the upper opening 25 in the upper arm 24 of the clip 20, through the base can aperture 8 of the flange 3, through the middle opening 39 of the middle arm 36 in the clip 20, and finally into and threadably engaging the nut opening 16 of the nut 12 within the lower opening 32 of the lower arm 28 of the clip 20.

As discussed above, the present disclosure anticipates clips 20 that do not include a middle arm 36, but instead retain the nut 12 between the base can flange 3 and the clip 20 by merely the lower arm 28. For example, the lower arm 28 may comprise a pocket shaped recess to prevent rotation of the nut 12 and to upwardly retain the nut 12 against the lower surface 5 of the flange 3 when the clip 20 is attached onto the base can flange 3.

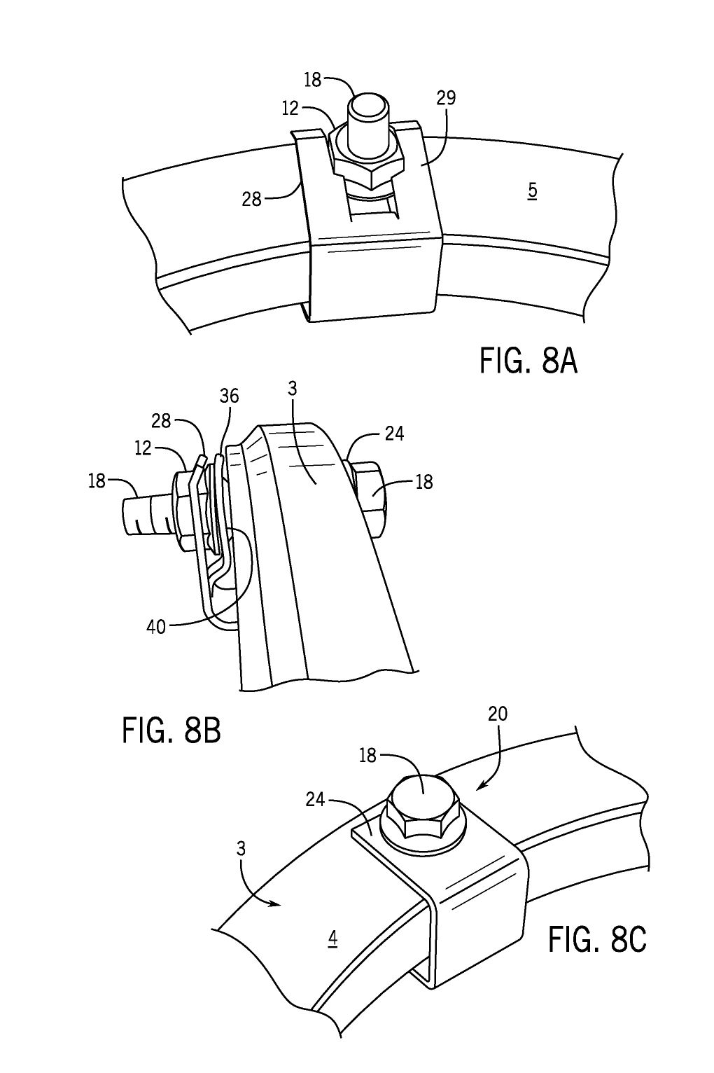

FIG. 7B further discloses the alignment feature 40 of the middle arm 36 being aligned and nested within the chamfer 9 in the lower surface 5 of the base can flange 3, which provides fixation for the clip 20 relative to the base can flange 3 before a bolt or coupling system 18 more generally is inserted therein. The present inventors have found that the alignment feature 40 and chamfer 9 are not required of the presently disclosed fastener system 100, but are useful improvements ton incorporate into newly installed base cans 1 to simplify repairs to the presently disclosed fastening system 100 in the future. This alignment feature is also shown in FIGS. 4A-B. FIGS. 8A-C depict one embodiment of the presently disclosed fastening system 100 installed on a flange 3 of an existing base can 1 known in the art. The base can flange 3 is shown without sidewalls to provide unobstructed viewing. As can be seen, since the flange 3 does not have a chamfer, the raised alignment feature 40 of the clip 20 is not engaged therein. However, the clip 20 nonetheless functions equally well without base cans 1 that incorporate this alignment feature.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A fastening system for coupling an object to a base can, the base can having a flange with an upper surface and a lower surface and defining a plurality of base can apertures therethrough, wherein the object defines a plurality of object openings therethrough, the fastening system comprising:
a clip having an upper arm and a lower arm that each extend from a spreader, wherein the spreader separates the upper arm and lower arm, and wherein the clip is configured to engage the flange such that the flange is positioned between the upper arm and the lower arm;
a nut having a nut base and a plurality of sides that extend perpendicularly from the nut base, wherein the nut defines a nut opening having internal threads therein, wherein the clip is configured to retain the nut between the lower arm and the lower surface of the flange such that the nut opening is aligned to a base can aperture of the plurality of base can apertures; and
a coupling system having a threaded member, wherein the coupling system is configured to couple the object to the base can;
wherein when the object is coupled to the base can, the threaded member extends at least through one of each of the plurality of object openings in the object and the plurality of base can apertures in the flange, and wherein the threaded member extends at least partially into the nut opening to engage the nut.

2. The fastening system according to claim 1, wherein the coupling system further includes a top nut that threadably engages the threaded member, wherein when the object is coupled to the base can, the threaded member is threadably engaged with both the nut and the top nut.

3. The fastening system according to claim 2, wherein the threaded member has a stop configured to limit the threadably engagement with each of the nut and the top nut.

4. The fastening system according to claim 3, wherein the threaded member has a first end and a second end opposite the first end, wherein the first end has a non-circular cross section configured to be engageable by an external tool such that the threaded member is rotatable to threadably engage the second end with the nut.

5. The fastening system according to claim 1, further comprising a spacer that is positionable between the upper surface of the flange and the object, the spacer having an upper surface and a lower surface and defining a plurality of spacer openings therethrough, wherein the lower surface of the spacer further defines a plurality of clip grooves extending towards the upper surface of the spacer, wherein the plurality of spacer openings coincide with the plurality of clip grooves, wherein the plurality of clip grooves are configured to accommodate the upper arm of the clip therein such that the upper arm does not prevent the lower surface of the spacer from contacting the upper surface of the flange when the clip is engaged with the flange and the spacer is positioned between the flange and the object.

6. The fastening system according to claim 5, wherein the fastening system is configured to couple the object to the base can when the object is positioned on a seating ring, wherein the seating ring is positioned between the object and the spacer, wherein the seating ring defines a plurality of seating ring openings therethrough, and wherein the threaded member also extends through a seating ring opening of the plurality of seating ring openings.

7. The fastening system according to claim 1, wherein the nut base has a lip that extends perpendicularly from the plurality of sides, wherein the lower arm engages the lip to retain the nut between the lower arm and the lower surface of the flange.

8. The fastening system according to claim 7, wherein the lower arm defines a notch, wherein the notch engages with at least one side of the plurality of sides of the nut to prevent rotation of the nut relative to the clip.

9. The fastening system according to claim 8, wherein the lower arm comprises two fingers each having a tip end opposite of a base end that is coupled to the spreader, wherein the two fingers together define the notch therebetween, and wherein at least one tip end is bent towards the upper arm of the clip.

10. The fastening system according to claim 7, wherein the clip further comprises a middle arm that extends from the spreader between the upper arm and the lower arm, wherein when the clip is engaged on the flange the flange is positioned between the upper arm and the middle arm, and wherein the lip is retained between the middle arm and the lower arm when the nut is retained between the lower arm and the lower surface of the flange.

11. The fastening system according to claim 10, wherein the base can further comprises a plurality of base can alignment features that correspond to the plurality of base can apertures, wherein the clip further comprises a clip alignment feature, and wherein the clip alignment feature is configured to removably engage with a base can alignment feature of the plurality of base can alignment features to align the clip on the flange.

12. The fastening system according to claim 11, wherein the plurality of base can alignment features are frustoconical chamfers defined within the lower surface of the flange that extend towards the upper surface of the flange, and wherein the clip alignment feature is a raised frustoconical shape that extends towards the upper arm of the clip from the middle arm of the clip.

13. The fastening system according to claim 1, wherein the internal threads of the nut opening have a varying pitch.

14. The fastening system according to claim 1, further comprising a pair of wedge lock washers, wherein the threaded member extends through the pair of wedge lock washers when the object is coupled to the base can.

15. The fastening system according to claim 1, wherein the base can has a cross section that is circular, and wherein the spacer and seating ring each have a shape that is annular.

16. The fastening system according to claim 1, wherein the upper arm is parallel to the lower arm and perpendicular to the spreader.

17. The fastening system according to claim 1, wherein the upper arm defines an upper opening therein, wherein the lower arm defines a lower opening therein, and wherein the threaded member also extends through the upper opening and at least partially into the lower opening when the object is coupled to the base can.

18. The fastening system according to claim 1, wherein the object is an extension positioned on the upper surface of the flange, and wherein the clip is configured to simultaneously engage both the flange and the extension, wherein both the flange and the extension are positioned between the upper arm and the lower arm of the clip when the clip is engaged with the flange and the extension.

19. A fastening system for coupling an object to a base can with a coupling system and a nut, wherein the nut has a lip and defines a nut opening therein, wherein the base can has a sidewall with an upper end and a lower end that is opposite the upper end, wherein the base can has a flange that extends radially inwardly and perpendicularly from the upper end of the sidewall, wherein the flange has an upper surface and a lower surface and defines a plurality of base can apertures therethrough, and wherein the object defines a plurality of object openings therethrough, the fastening system comprising:
a clip configured to engage the flange of the base can, wherein the clip has a spreader and an upper arm, a middle arm, and a lower arm that are each coupled to and separated by the spreader, wherein the upper arm defines an upper opening therethrough, wherein the middle arm defines a middle opening therethrough, wherein the lower arm defines a lower opening therethrough, wherein the upper opening, the middle opening, and the lower opening are axially aligned, and wherein the clip is configured to engage the flange such that the flange is positioned between the upper arm and the middle arm; and
a spacer that is positionable between the upper surface of the flange and the object, wherein the spacer has an upper surface and a lower surface and defines a plurality of spacer openings therethrough, wherein the lower surface of the spacer further defines a plurality of clip grooves that extend towards the upper surface of the spacer, wherein the plurality of spacer openings coincide with the plurality of clip grooves, wherein the plurality of clip grooves are configured to accommodate the upper arm of the clip therein such that the upper arm does not prevent the lower surface of the spacer from contacting the upper surface of the flange when the clip is engaged with the flange and the spacer is positioned between the flange and the object;
wherein the clip is configured to retain the lip of the nut between the middle arm and the lower arm such that the nut opening is aligned to one base can aperture of the plurality of base can apertures; and
wherein when the object is coupled to the base can, the threaded member extends at least through one of each of the plurality of object openings in the object, the plurality of spacer openings, the upper opening of the clip, the plurality of base can apertures in the flange, and the middle opening of the clip, and wherein the threaded member extends at least partially into the nut opening to engage the nut.

20. A fastening system for coupling an object to a base can, wherein the base can has a sidewall with an upper end and a lower end that is opposite the upper end, wherein the base can has a flange that extends radially inwardly and perpendicularly from the upper end of the sidewall, wherein the flange has an upper surface and a lower surface and defining a plurality of base can apertures therethrough, and wherein the object defines a plurality of object openings therethrough, the fastening system comprising:
a clip configured to engage the flange of the base can, wherein the clip has a spreader and an upper arm, a middle arm, and a lower arm that are each coupled to and separated by the spreader, wherein the upper arm defines an upper opening therethrough, wherein the middle arm defines a middle opening therethrough, wherein the lower arm defines a lower opening therethrough, wherein the upper opening, the middle opening, and the lower opening are axially aligned, and wherein the clip is configured to engage the flange such that the flange is positioned between the upper arm and the middle arm;
a coupling system having a threaded member;
a nut having a lip and a plurality of sides that extend perpendicularly from the lip, wherein the nut defines a nut opening having internal threads therein, wherein the internal threads are threadably engageable with the threaded member of the coupling system, and wherein the clip is configured to retain the lip between the middle arm and the lower arm; and
a spacer that is positionable between the upper surface of the flange and the object, wherein the spacer has an upper surface and a lower surface and defines a plurality of spacer openings therethrough, wherein the lower surface of the spacer further defines a plurality of clip grooves that extend towards the upper surface of the spacer, wherein the plurality of spacer openings coincide with the plurality of clip grooves, wherein the plurality of clip grooves are configured to accommodate the upper arm of the clip therein such that the upper arm does not prevent the lower surface of the spacer from contacting the upper surface of the flange when the clip is engaged with the flange and the spacer is positioned between the flange and the object;
wherein the clip is configured to retain the lip of the nut between the middle arm and the lower arm such that the nut opening is aligned to one base can aperture of the plurality of base can apertures; and
wherein when the object is coupled to the base can, the threaded member extends at least through one of each of the plurality of object openings in the object, the plurality of spacer openings, the upper opening of the clip, the plurality of base can apertures in the flange, and the middle opening of the clip, and wherein the threaded member extends at least partially into the nut opening to engage the nut.
